(19) United States
(12) Patent Application Publication
(10) Pub. No.: US 2016/0297146 A1
(43) Pub. Date: Oct. 13, 2016

(54) EXPOSURE DEVICE FOR THREE-DIMENSIONAL PRINTER, THREE-DIMENSIONAL PRINTER AND THREE-DIMENSIONAL PRINTING METHOD

(71) Applicant: BOE TECHNOLOGY GROUP CO., LTD., Beijing (CN)

(72) Inventor: Yanbing WU, Beijing (CN)

(21) Appl. No.: 15/079,376

(22) Filed: Mar. 24, 2016

(30) Foreign Application Priority Data
Apr. 9, 2015 (CN) 201510166720.X

(51) Int. Cl. B29C 67/00

(52) U.S. Cl. CPC B29C 67/0088; B29C 67/0066; B29C 67/0092; B33Y 10/00

(57) ABSTRACT

The present invention discloses an exposure device for three-dimensional printer, a three-dimensional printer and a three-dimensional printing method. The exposure device comprises a backlight source and a pixel panel disposed at a light-exiting side of the backlight source, the pixel panel including a plurality of pixel units arranged in an array and a plurality of switching elements in one-to-one correspondence with the plurality of pixel units and used to control the corresponding pixel units to be light transmissive or non-light-transmissive so as to enable the pixel panel to display an image to he displayed. The exposure device further comprises an outer frame for constraining a moving range of the pixel panel. The concepts of the present invention can efficiently reduce the volume of three-dimensional printer. Moreover, the pixel panel of the present invention can slightly move within the outer frame, thereby improving uniformity of exposure and printing effect.

### FIELD OF THE INVENTION

The present invention relates to the field of three-dimensional printing technology, and specifically relates to an exposure device for a three-dimensional printer, a three-dimensional printer and a three-dimensional printing method.

### BACKGROUND OF THE INVENTION

Three-dimensional printing technology is such a technology that layers of a specific material, such as metal powder, ceramic powder, plastic, cellular tissue, etc., are stacked layer by layer by means of laser beam, heat fusing jetting and the like through a CNC Prototyping System based on a three-dimensional computer model divided into slices by software, so as to manufacture a product. Unlike the conventional manufacture technologies of manufacturing products by shaping and cutting raw materials by mechanical means such as molding and milling, the three-dimensional printing technology converts a three-dimensional object into a plurality of two-dimensional planes and by processing and stacking a material layer by layer, so the complexity of manufacture is significantly reduced. In such digitalized manufacture mode, a component with any shape can be directly produced from computer graphic data without complex process, huge machine and enormous labor force, thus making the manufacture more convenient.

A structure of an existing three-dimensional printer is illustrated in FIG. 1. Liquid resin 1, which can be cured under irradiation of light having a particular wavelength, is provided in a material tank 2 through which light having a certain wavelength can pass. Light emitted from a projector 3, which outputs light capable of curing the resin, is irradiated onto the material tank 2. A printing platform 5 is provided on a pillar 4 and can be moved upward and downward along the pillar 4. The whole apparatus is covered by a case 6 for sealing-off and light-shielding.

The operation process thereof is as follows. First, a profile of an object, as illustrated in FIG. 2a, is obtained by software, and processed, by software, to layered information consisting of information of a plurality of single-layer structures, as illustrated in FIG. 2b, and then the layered information is inputted into the three-dimensional printer. Referring to FIG. 1, a lower surface of the printing platform 5 is immersed into the liquid resin 1, and a distance between the lower surface of the printing platform 5 and an upper surface of the bottom of the material tank 2 is a during printing, of a first single-layer structure, where a is a thickness of the single-layer structure. Then, the projector 3 displays an image corresponding to the single-layer structure, and exposes the liquid resin between the lower surface of the printing platform 5 and the upper surface of the bottom of the material tank 2 so as to form the first single-layer structure. Thereafter, the printing platform 5 rises by a distance a such that a layer of liquid resin with a thickness of a is formed between the first single-layer structure and the upper surface of the bottom of the material tank 2. At this time, the projector 3 displays an image corresponding to a second single-layer structure to perform exposure. The above process is repeated until the printing is completed. However, the existing three-dimensional printer is bulky and has a poor uniformity of exposure due to the large bulk of the projector 3.

### SUMMARY OF THE INVENTION

An object of the present invention is to provide an exposure device for a three-dimensional printer, a three-dimensional printer and a three-dimensional printing method so as to reduce the volume of a three-dimensional printer and improve the uniformity of exposure for the three-dimensional printer.

As a first aspect of the present invention, there is provided an exposure device for a three-dimensional printer, comprising a backlight source and a pixel panel disposed at a light-exiting side of the backlight source, wherein the pixel panel includes a plurality of pixel units arranged in an array and a plurality of switching elements in one-to-one correspondence with the plurality of pixel units, and the switch element is used to control the corresponding pixel unit to be light transmissive or non-light-transmissive, so as to enable the pixel panel to display an image to be printed.

Preferably, a shading region is disposed between adjacent pixel units, both the switching element and a wire connecting with the switching element are located in the shading region.

Preferably, the exposure device further comprises an outer frame for constraining a moving range of the pixel panel and a pushing means capable of pushing the pixel panel to move along a first direction and a second direction within an inner space defined by the outer frame, wherein a width of the inner space defined by the outer frame in the first direction equals to a sum of a width of the pixel panel in the first direction and a width of the shading region between adjacent two pixel units in the first direction, and a width of the inner space defined by the outer frame in the second direction equals to a sum of a width of the pixel panel in the second direction and a width of the shading region between adjacent two pixel units in the second direction.

Preferably, the pushing means includes four pushers, wherein two pushers are disposed at both sides of the pixel panel in the first direction, respectively, and the other two pushers are disposed at both sides of the pixel panel in the second direction, respectively.

Preferably, a width of the pixel unit in the first direction equals to that of the shading region between the adjacent two pixel units in the first direction, and a width of the pixel unit in the second direction equals to that of the shading region between the adjacent two pixel units in the second direction.

Preferably, the pixel panel is any one of a liquid crystal panel, a micro electro mechanical (MEM) panel and an electrochromic panel.

As a second aspect of the present invention, there is provided a three-dimensional printer, comprising a backlight source and the above-mentioned exposure device provided by the present invention, wherein the exposure device is disposed at a light-exiting side of the backlight source and used for exposing a printing material, the three-dimensional printer further comprises a printing platform and a material tank, which is disposed at a light-exiting side of the pixel panel and provided therein with a printing material, a lower surface of the printing platform is capable of moving upward and downward in the material tank so as to enable the three-dimensional printer to print an object to be printed layer by layer, and light emitted from the backlight source is capable of curing the printing material.

Preferably, the three-dimensional printer further comprises a pillar, a connecting member is provided on the printing platform and one end of the connecting member is slidably provided on the pillar so as to allow the lower surface of the printing platform to move in the material tank in a vertical direction.

Preferably, the three-dimensional printer further comprises a controller connected with the connecting member, the backlight source and the pixel panel, respectively, and used for controlling up and down of the connecting member, on and off of the backlight source, and on and off of each switching element in the pixel panel to cause the corresponding pixel unit to be light transmissive or non-light-transmissive.

As a third aspect of the present invention, there is provided a three-dimensional printing method for the above-mentioned three-dimensional printer, comprising steps of: turning on the backlight source; inputting data for a current printing image to switching elements of the pixel panel and controlling the corresponding pixel units to be light transmissive or non-light-transmissive by the switching elements to enable the pixel panel to display the current printing image; and exposing a printing material by the backlight source and the pixel panel to obtain a single-layer structure corresponding to the current printing image.

Preferably, a shading region is disposed between adjacent pixel units, and the exposure device further comprises an outer frame for constraining a moving range of the pixel panel, wherein a width of an inner space defined by the outer frame in a first direction equals to a sum of a width of the pixel panel in the first direction and a width of the shading region between adjacent two pixel units in the first direction, and a width of the inner space defined by the outer frame in a second direction equals to a sum of a width of the pixel panel in the second direction and a width of the shading region between adjacent two pixel units in the second direction;

during printing of adjacent two single-layer structures, a step of printing the former single-layer structure comprises:

inputting, to the switching elements of the pixel panel, data for a printing image corresponding to the former single-layer structure, and controlling the corresponding pixel units to be light transmissive or non-light-transmissive by the switching elements to enable the pixel panel to display the printing image corresponding to the former single-layer structure,

positioning the pixel panel at a first position in the inner space defined by the outer frame, and performing a first exposure for the former single-layer structure,

moving the pixel panel to a second position in the inner space defined by the outer frame, and performing a second exposure for the former single-layer structure,

moving the pixel panel to a third position in the inner space defined by the outer frame, and performing a third exposure for the former single-layer structure, and

moving the pixel panel to a fourth position in the inner space defined by the outer frame, and performing a fourth exposure for the former single-layer structure, so as to obtain the former single-layer structure; and

a step of printing the latter single-layer structure comprises:

inputting, to the switching elements of the pixel panel, data for a printing image corresponding to the latter single-layer structure, and controlling the corresponding pixel units to be light transmissive or non-light-transmissive by the switching elements to enable the pixel panel to display the printing image corresponding to the latter single-layer structure,

returning the pixel panel to the first position in the inner space defined by the outer frame, and performing a first exposure for the latter single-layer structure,

moving the pixel panel to the second position in the inner space defined by the outer frame, and performing a second exposure for the latter single-layer structure,

moving the pixel panel to the third position in the inner space defined by the outer frame, and performing a third exposure for the latter single-layer structure, and

moving the pixel panel to the fourth position in the inner space defined by the outer frame, and perforating a fourth exposure for the latter single-layer structure, so as to obtain the latter single-layer structure;

wherein the first position, the second position, the third position and the fourth position are positions obtained sequentially by moving the pixel panel clockwise or counterclockwise in the inner space defined by the outer frame, and two adjacent sides of the pixel panel overlaps with two adjacent sides of the inner space defined by the outer frame when the pixel panel is located at the first position, the second position, the third position or the fourth position.

Alternatively, a step of printing the latter single-layer structure comprising:

inputting, to the switching elements of the pixel panel, data for a printing image corresponding to the latter single-layer structure, and controlling the corresponding pixel units to he light transmissive or non-light-transmissive by the switching elements to enable the pixel panel to display the printing image corresponding to the latter single-layer structure;

keeping the pixel panel at the fourth position in the inner space defined by the outer frame, and performing a first exposure for the latter single-layer structure; and

sequentially moving the pixel panel to the first position, the second position and the third position in the inner space defined by the outer frame, and performing a second exposure, a third exposure and a fourth exposure for the latter single-layer structure, respectively, so as to obtain the latter single-layer structure.

Preferably, the first position, the second position, the third position and the fourth position are located at a top left corner, top right corner, a bottom right corner and a bottom left corner in the inner space defined by the outer frame, respectively.

Preferably, the three-dimensional printing method further comprises a step of determining an image corresponding to each single-layer structure of the object to be printed before turning on the backlight source.

The present invention uses the backlight source and the pixel panel to replace the projector in the prior art to expose the printing material, which can efficiently reduce the volume of three-dimensional printer. Moreover, the pixel panel of the present invention is capable of slightly moving within the inner space defined by the outer frame so that the printing material shaded by the shading region before the pixel panel is moved can be exposed, thereby improving uniformity of exposure as well as printing effect.

### BRIEF DESCRIPTION OF THE DRAWINGS

The accompanying drawings, which constitute a part of the specification, are provided for further understanding of the present invention, and for explaining the present invention together with the following specific implementations, but not intended to limit the present invention.

FIG. 1 is a schematic structural diagram of an existing three-dimensional printer;

FIGS. 2a to 2b are schematic diagrams illustrating a process of dividing a computer model of an object to be printed into slices by software;

FIG. 3 is a side view of an exposure device in an embodiment of the present invention;

FIG. 4 is a plan view of a pixel panel in an embodiment of the present invention;

FIG. 5 is a plan view of an exposure device in an embodiment of the present invention;

FIG. 6 is a schematic diagram of a three-dimensional printer in an embodiment of the present invention;

FIG. 7 is a schematic diagram of an exposure process in an embodiment of the present invention; and

FIG. 8 is a schematic diagram of another exposure process in an embodiment of the present invention.

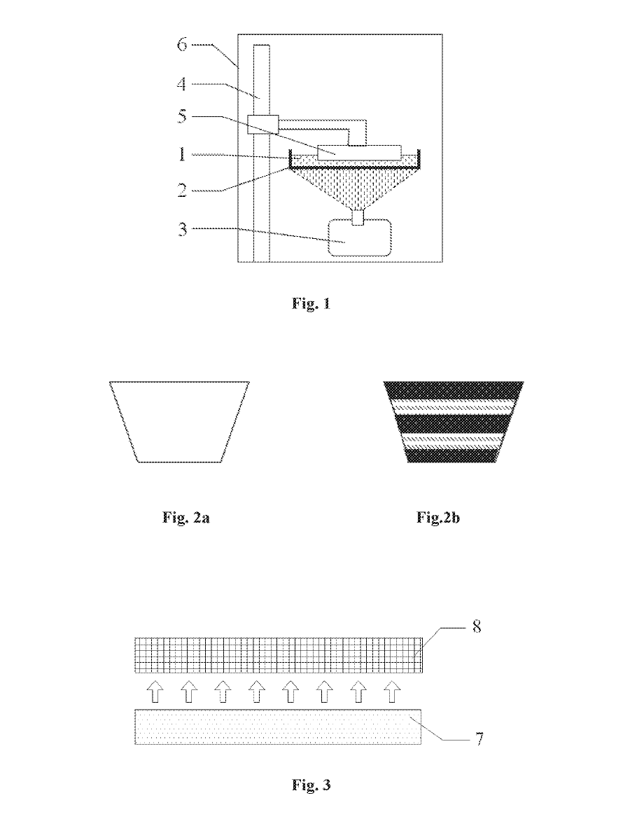

### DETAILED DESCRIPTION OF THE EMBODIMENTS

The specific implementations of the present invention will be described in detail below with reference to the accompanying drawings. It should be understood that the specific implementations to be described herein are merely used for describing and explaining the present invention and not for limiting the present invention.

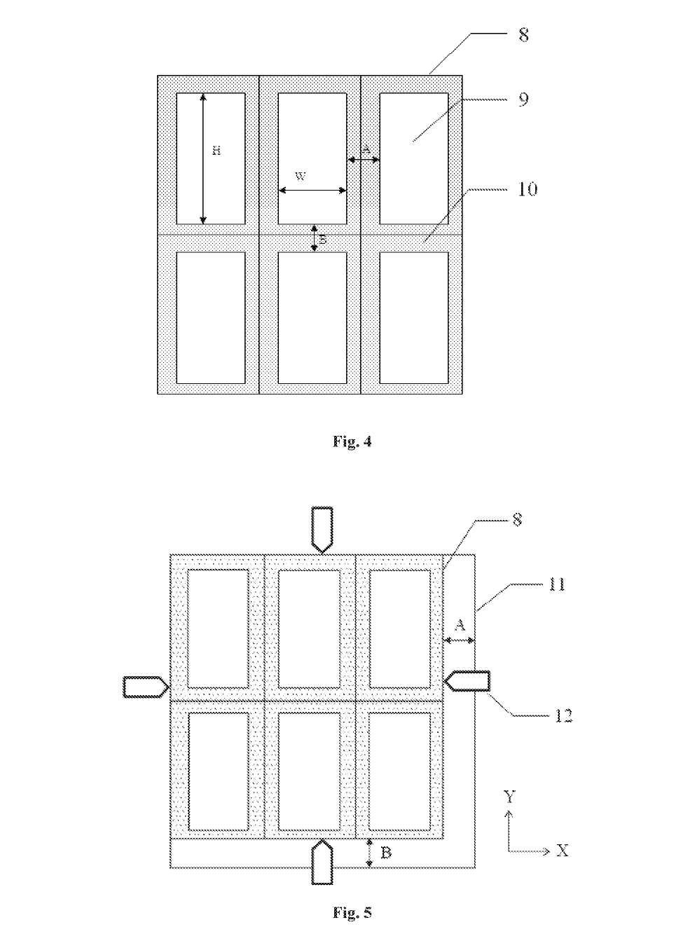

An embodiment of the present invention provides an exposure device for a three-dimensional printer, as illustrated in FIG. 3. The exposure device comprises a backlight source 7 and a pixel panel 8 disposed at a light-exiting side of the backlight source 7, wherein the pixel panel 8 includes a plurality of pixel units 9 arranged in an array (referring to FIG. 4) and a plurality of switching elements (not shown) in one-to-one correspondence with the plurality of pixel units 9, and the switching element is used to control the corresponding pixel unit 9 to be light transmissive or non-light-transmissive, so as to enable the pixel panel 8 to display an image to be printed.

When the exposure device is used in a three-dimensional printer, the image to be printed is formed through the light transmissive pixel units 9 of the pixel panel 8, and light emitted from the backlight source 7 passes through the light transmissive pixel units 9 and irradiates onto the printing material to cure the irradiated printing material, thereby obtaining one single-layer structure in an object to be printed.

Compared to the case of using a projector as an exposure device in the prior art, the exposure device used in the present invention has an advantage of small volume, thereby efficiently reducing the volume of the three-dimensional printer and facilitating miniaturization of the three-dimensional printer.

In order to make boundary of the pixel unit 9 more clear, preferably, a shading region 10 is disposed between adjacent pixel units 9, both the switching element and a wire connected with the switching element are located in the shading region 10. The pixel panel 8 in the present invention may be any one of a liquid crystal panel, a micro electro mechanical (MEM) panel and an electrochromic panel, and the switching elements are part of control circuit of the above-mentioned panel.

Specifically, as illustrated in FIGS. 4 and 5, in the pixel panel 8, a width of the shading region 10 between adjacent two pixel units 9 in X direction (i.e., a first direction) is A, and a width of the shading region 10 between adjacent two pixel units 9 in Y direction (i.e., a second direction) is B. The exposure device further comprises an outer frame 11 for constraining a moving range of the pixel panel 8 and a pushing means capable of pushing the pixel panel 8 to move along X direction and Y direction within an inner space defined by the outer frame 11, wherein a width of the inner space defined by the outer frame 11 in X direction equals to the sum of a width W of the pixel panel 8 in X direction and A, and a width of the inner space defined by the outer frame 11 in Y direction equals to the sum of a width H of the pixel panel 8 in Y direction and B.

During the use of the exposure device provided by the present invention, the pixel panel 8 may be pushed to four corners of the outer frame 11 sequentially and four exposing operations are performed so as to obtain one corresponding single-layer structure. Usually, the exposure amount at the shading region 10 is very small, whereas the width W of the pixel unit 9 in X direction is larger than A and the width H thereof in Y direction is larger than B, which results in that an exposure amount at a middle portion of the pixel unit 9 is much larger than that at a periphery portion so that the exposure over the pixel unit 8 is nonuniform. The pixel panel 8 in the present invention is capable of slightly moving within the inner space defined by the outer frame 11, and the moving ranges in X and Y directions are A and B, respectively, so that the printing material shaded by the shading region 10 before the pixel panel 8 is moved can be exposed, thereby improving uniformity of exposure as well as printing effect.

Specifically, the pushing means in the present invention includes four pushers 12, wherein two pushers 12 are disposed at both sides of the pixel panel 8 in X direction, respectively, and the other two pushers 12 are disposed at both sides of the pixel panel 8 in Y direction, respectively, as illustrated in FIG. 5. It can be understood that any other pushing means may be adopted in the present invention to push the pixel panel 8, as long as it can slightly move the pixel panel 8 within the inner space defined by the outer frame 11, and the description thereof is omitted herein.

Preferably, the width W of the pixel unit 9 in X direction may be set to be equal to A, and the width H of the pixel unit 9 in Y direction may be set to be equal to B. In the case where W=A and H=B, when exposure operations are performed at four corners of the outer frame 11 through the pixel panel 8, the corresponding four exposure areas barely overlap with each other, thereby further improving uniformity of exposure.

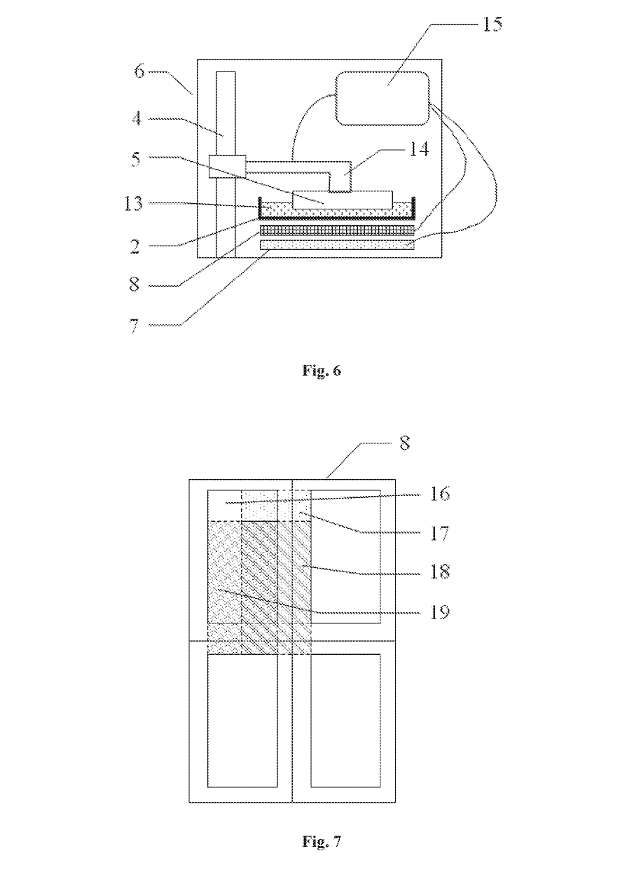

The invention also provides a three-dimensional printer comprising a backlight source and the above-mentioned exposure device provided by the present invention, where the exposure device is disposed at a light-exiting side of the backlight source and used for exposing a printing material. As illustrated in FIG. 6, the three-dimensional printer also comprises a printing platform 5 and a material tank 2, which is disposed at a light-exiting side of the pixel panel 8 and is provided therein with a liquid printing material 13, a lower surface of the printing platform 5 is capable of moving upward and downward in the material tank 2, and light emitted from the backlight source 7 is capable of curing the printing material 13.

As described above, the three-dimensional printer provided by the present invention has the advantages of small volume, high uniformity of exposure and good printing effect.

The printing material 13 may be a particular material such as liquid resin, metal powder, ceramic powder, cellular tissue or the like and can be cured under irradiation of light having a particular wavelength. The lower surface of the printing platform 5 is immersed into the liquid printing material 13, and during printing of a first single-layer structure, a distance between the lower surface of the printing platform 5 and an upper surface of the bottom of the material tank 2 is a, where a is a thickness of the single-layer structure. Then, the pixel panel 8 displays an image corresponding to the single-layer structure and exposes the printing material 13 between the lower surface of the printing platform 5 and the upper surface of the bottom of the material tank 2, so as to form the first single-layer structure. Thereafter, the printing platform 5 rises by a distance a such that one layer of printing material 13 with a thickness of a is formed between the first single-layer structure and the upper surface of the bottom of the material tank 2. At this time, the pixel panel 8 displays an image corresponding to a second single-layer structure and performs exposure so as to form the second single-layer structure. The above process is repeated until the printing is completed. The whole apparatus is covered by a case 6 for sealing-off and light-shielding.

The three-dimensional printer further comprises a pillar 4, a connecting member 14 is provided on the printing platform 5, and one end of the connecting member 14 is slidably provided on the pillar 4 such that the lower surface of the printing platform 5 is capable of moving in the material tank 2 in a vertical direction.

The three-dimensional printer further comprises a controller 15 connected with the connecting member 14, the backlight source 7 and the pixel panel 8, respectively, and used for controlling up and down of the connecting member 14, on and off of the backlight source 7, and on and off of each switching element in the pixel panel 8 to control the corresponding pixel unit 9 to be light transmissive or non-light-transmissive, thereby displaying the image to be printed.

The present invention further provides a three-dimensional printing method for the above-mentioned three-dimensional printer, and referring to FIGS. 4 to 6, the method comprises:

Step 1: turning on the backlight source 7;

Step 2: inputting data for a current printing image to switching elements of the pixel panel 8, and controlling the corresponding pixel units 9 to be light transmissive or non-light-transmissive by the switching elements, so as to enable the pixel panel 8 to display the current printing image; and

Step 3: exposing the printing material 13 by the backlight source 7 and the pixel panel 8 to obtain a single-layer structure corresponding to the current printing image.

The present invention uses the backlight source 7 and the pixel panel 8 to replace the projector in the prior art to expose the printing material 13, which can efficiently reduce the volume of three-dimensional printer.

Further, a shading region 10 is disposed between adjacent pixel units 9, where a width of the shading region 10 between adjacent two pixel units 9 in X direction is A, and a width of the shading region 10 between adjacent two pixel units 9 in Y direction is B. The exposure device further comprises an outer frame 11 for constraining a moving range of the pixel panel 8, wherein a length of the inner space defined by the outer frame 11 in X direction equals to the sum of a length W of the pixel panel 8 in X direction and A, and a length of the inner space defined by the outer frame 11 in direction equals to the sum of a length H of the pixel panel 8 in Y direction and B.

During printing of adjacent two single-layer structures, a step of printing the former single-layer structure comprises the following steps.

First, data for a printing image corresponding to the former single-layer structure is inputted to the switching elements of the pixel panel 8, and the corresponding pixel units 9 are controlled to be light transmissive or non-light-transmissive by the switching elements, so as to enable the pixel panel to display the printing image corresponding to the former single-layer structure.

Next, an exposure process is performed with reference to FIG. 7. Specifically, firstly, the pixel panel 8 is positioned at a top left corner of the inner space defined by the outer frame 11 (not shown in FIG. 7), and a first exposure is performed on a first exposure area 16 for the former single-layer structure; secondly, the pixel panel 8 is moved to a top right corner in the inner space defined by the outer frame 11, and a second exposure is performed on a second exposure area 17 for the former single-layer structure; thirdly, the pixel panel 8 is moved to a bottom right corner in the inner space defined by the outer frame 11, and a third exposure is performed on a third exposure area 18 for the former single-layer structure; and lastly, the pixel panel 8 is moved to a bottom left corner in the inner space defined by the outer frame 11, and a fourth exposure is performed on a fourth exposure area 19 for the former single-layer structure, thus obtaining the former single-layer structure.

The pixel panel 8 of the present invention is capable of slightly moving within the inner space defined by the outer frame 11 so that the printing material 13 shaded by the shading region 10 before the pixel panel 8 is moved can be exposed, thereby improving uniformity of exposure as well as printing effect.

In an embodiment of the present invention, a pushing means may be used to push the pixel panel 8 to move slightly. The pushing means includes four pushers 12, wherein two pushers 12 are disposed at both sides of the pixel panel 8 in X direction, respectively, and the other two pushers 12 are disposed at both sides of the pixel panel 8 in Y direction, respectively, as illustrated in FIG. 5. The pixel panel 8 may be pushed to move up, down, left and right by the pushers 12 disposed at four sides of the pixel panel 8, respectively.

The latter single-layer structure of the two adjacent single-layer structures may be printed by means of two implementations.

In the first implementation, the step of printing the latter single-layer structure comprises the following steps.

First, data for a printing image corresponding to the latter single-layer structure is inputted to the switching elements of the pixel panel 8, and the corresponding pixel units 9 are controlled to be light transmissive or non-light-transmissive by the switching elements, so as to enable the pixel panel 8 to display the printing image corresponding to the latter single-layer structure.

Next, the following exposure process is performed: returning the pixel panel 8 to the top left corner of the inner space defined by the outer frame 11, and performing a first exposure on the first exposure area 16 for the latter single-layer structure ; and sequentially moving the pixel panel 8 to the top right corner, the bottom right corner and the bottom left corner in the inner space defined by the outer frame 11, and performing a second exposure, a third exposure and a fourth exposure on the second to fourth exposure areas 17 to 19 for the latter single-layer structure, respectively, thus obtaining the latter single-layer structure.

In the second implementation, the step of printing the latter single-layer structure comprises the following steps.

First, data for a printing image corresponding to the latter single-layer structure is inputted to the switching elements of the pixel panel 8, and the corresponding pixel units 9 are controlled to be light transmissive or non-light-transmissive by the switching elements, so as to enable the pixel panel 8 to display the printing image corresponding to the latter single-layer structure.

Next, the following exposure process is performed: keeping the pixel panel 8 at the bottom left corner of the inner space defined by the outer frame 11, that is, the position of the fourth exposure for the former single-layer structure, and performing a first exposure on the fourth exposure area 19 for the latter single-layer structure; and sequentially moving the pixel panel 8 to the top left corner, the top right corner and the bottom right corner in the inner space defined by the outer frame 11, and performing a second exposure, a third exposure and a fourth exposure on the first to third exposure areas 16 to 18 for the latter single-layer structure, respectively, and thus obtaining the latter single-layer structure.

In the present embodiment, the first exposure area 16, the second exposure area 17, the third exposure area 18 and the fourth exposure area 19 correspond to the top left corner, the top right corner, the bottom right corner and the bottom left corner of the inner space defined by the outer frame 11, respectively, but the present invention is not limited thereto. The first exposure area 16, the second exposure area 17, the third exposure area 18 and the fourth exposure area 19 may correspond to a first position, a second position, a third position and a fourth position in the inner space defined by the outer frame 11, respectively, wherein the first position, the second position, the third position and the fourth position are positions obtained sequentially by moving the pixel panel 8 clockwise or counterclockwise within the inner space defined by the outer frame 11, and two adjacent sides of the pixel panel 8 overlaps with two adjacent sides of the inner space defined by the outer frame 11 when the pixel panel 8 is located at the first position, the second position, the third position or the fourth position. For example, the first exposure area 16, the second exposure area 17, the third exposure area 18 and the fourth exposure area 19 may correspond to the top right corner, the bottom right corner, the bottom left corner, and the top left corner of the outer frame 11, respectively.

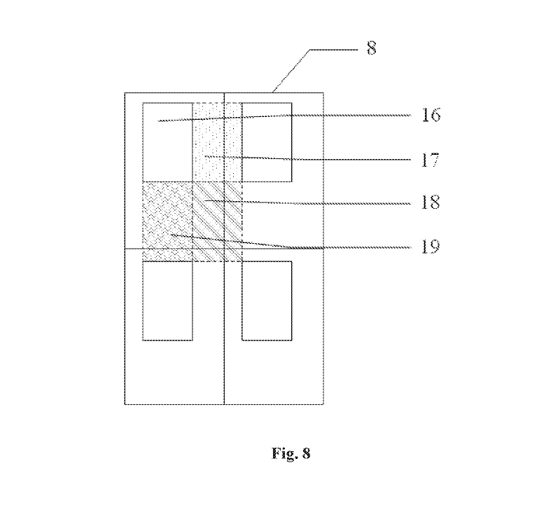

Preferably, the width W of the pixel unit 9 in X direction may he set to be equal to A, and the width H of the pixel unit 9 in Y direction may he set to be equal to B. In the case where W=A and H=B, as illustrated in FIG. 8, when exposure operations are performed at four corners of the outer frame 11 through the pixel panel 8, the corresponding four exposure areas 16-19 barely overlap with each other, thereby further improving uniformity of exposure.

It can be understood by those skilled in the art that the three-dimensional printing method further comprises a step of: determining an image corresponding to each single-layer structure of the object to be printed before turning on the backlight source 7. That is, the profile of the object to be printed is obtained and processed to layered printing image consisting of a plurality of single-layer structures by software, and then the printing images for the respective layers are inputted into the three-dimensional printer sequentially.

It can be understood that the foregoing implementations are merely exemplary implementations used for describing the principle of the present invention, but the present invention is not limited thereto. Those of ordinary skill in the art may make various variations and improvements without departing from the spirit and essence of the present invention, and these variations and improvements shall fall into the protection scope of the present invention.

What is claimed is:

1. An exposure device for a three-dimensional printer, comprising a backlight source and a pixel panel disposed at a light-exiting side of the backlight source, wherein the pixel panel includes a plurality of pixel units arranged in an array and a plurality of switching elements in one-to-one correspondence with the plurality of pixel units, the switching element is used to control the corresponding pixel unit to be light transmissive or non-light-transmissive, so as to enable the pixel panel to display an image to be displayed.

2. The exposure device according to claim 1, wherein a shading region is disposed between adjacent pixel units, both the switching element and a wire connected with the switching elements are located in the shading region.

3. The exposure device according to claim 2, further comprising an outer frame for constraining a moving range of the pixel panel and a pushing means capable of pushing the pixel panel to move along a first direction and a second direction within an inner space defined by the outer frame, wherein a width of the inner space defined by the outer frame in the first direction equals to a sum of a width of the pixel panel in the first direction and a width of the shading region between adjacent two pixel units in the first direction, and a width of the inner space defined by the outer frame in the second direction equals to a sum of a width of the pixel panel in the second direction and a width of the shading region between adjacent two pixel units in the second direction.

4. The exposure device according to claim 3, wherein the pushing means includes four pushers, two pushers are disposed at both sides of the pixel panel in the first direction, respectively, and the other two pushers are disposed at both sides of the pixel panel in the second direction, respectively.

5. The exposure device according to claim 3, wherein a width of the pixel unit in the first direction equals to that of the shading region between the adjacent two pixel units in the first direction, and a width of the pixel unit in the second direction equals to that of the shading region between the adjacent two pixel units in the second direction.

6. The exposure device according to claim 1, wherein the pixel panel is any one of a liquid crystal panel, a micro electro mechanical panel and an electrochromic panel.

7. A three-dimensional printer, comprising:
a backlight source;
the exposure device according to claim 1, the exposure device being disposed at a light-exiting side of the backlight source and being used for exposing a printing material;
a material tank, the material tank being disposed at a light-exiting side of the pixel panel and provided therein with a printing material able to be cured by light emitted from the backlight source; and
a printing platform whose lower surface is capable of moving upward and downward in the material tank, so as to enable the three-dimensional printer to print an object to be printed layer by layer.

8. The three-dimensional printer according to claim 7, further comprising a pillar, wherein a connecting member is provided on the printing platform, and one end of the connecting member is provided on the pillar in such a movable manner that the lower surface of the printing platform is capable of moving in the material tank in a vertical direction.

9. The three-dimensional printer according to claim 8, further comprising a controller connected with the connecting member, the backlight source and the pixel panel, respectively and for controlling up and down of the connecting member, on and off of the backlight source, and on and off of each switching element in the pixel panel to cause the corresponding pixel unit to be light transmissive or non-light-transmissive.

10. A three-dimensional printing method for the three-dimensional printer according to claim 7, the three-dimensional printing method comprising steps of:
turning on the backlight source;
inputting data for a current printing image to switching elements and controlling the corresponding pixel units to be light transmissive or non-light-transmissive by the switching elements, so as to enable the pixel panel to display the current printing image; and
exposing a printing material by the backlight source and the pixel panel to obtain a single-layer structure corresponding to the current printing image.

11. The three-dimensional printing method according in claim 10, wherein a shading region is disposed between adjacent pixel units, and the exposure device further comprises an outer frame for constraining a moving range of the pixel panel, a width of an inner space defined by the outer frame in a first direction is equal to a sum of a width of the pixel panel in the first direction and a width of the shading region between adjacent two pixel units in the first direction, and a width of the inner space defined by the outer frame in a second direction is equal to a sum of a width of the pixel panel in the second direction and a width of the shading region between adjacent two pixel units in the second direction;
during printing of adjacent two single-layer structures, a step of printing former single-layer structure comprises:
inputting data for a printing image corresponding to the former single-layer structure to the switching elements of the pixel panel, and controlling the corresponding pixel units to be light transmissive or non-light-transmissive by the switching elements, so as to enable the pixel panel to display the printing image corresponding to the former single-layer structure,
positioning the pixel panel at a first position in the inner space defined by the outer frame, and performing a first exposure for the former single-layer structure,
moving, the pixel panel to a second position in the inner space defined by the outer frame, and performing a second exposure for the former single-layer structure,
moving the pixel panel to a third position in the inner space defined by the outer frame, and performing a third exposure for the former single-layer structure, and
moving the pixel panel to a fourth position in the inner space defined by the outer frame, and performing a fourth exposure for the former single-layer structure, thereby obtaining the former single-layer structure; and
a step of printing the latter single-layer structure comprises:
inputting data for a printing image corresponding to the latter single-layer structure to the switching elements of the pixel panel, and controlling the corresponding pixel units to be light transmissive or non-light-transmissive by the switching elements, so as to enable the pixel panel to display the printing image corresponding to the latter single-layer structure,
returning the pixel panel to the first position in the inner space defined by the outer frame, and performing a first exposure for the latter single-layer structure,
moving the pixel panel to the second position in the inner space defined by the outer frame, and performing a second exposure for the latter single-layer structure,
moving the pixel panel to the third position in the inner space defined by the outer frame, and performing a third exposure for the latter single-layer structure, and
moving the pixel panel to the fourth position in the inner space defined by the outer frame, and performing a fourth exposure for the latter single-layer structure, thereby obtaining the latter single-layer structure,
wherein the first position, the second position, the third position and the fourth position are positions obtained sequentially by moving the pixel panel clockwise or counterclockwise within the inner space defined by the outer frame, and two adjacent sides of the pixel panel overlaps with two adjacent sides of the inner space defined by the outer frame when the pixel panel is located at the first position, the second position, the third position or the fourth position.

12. The three-dimensional printing method according to claim 10, wherein a shading region is disposed between adjacent pixel units, and the exposure device further comprises an outer frame for constraining a moving range of the pixel panel, a width of an inner space defined by the outer frame in a first direction is equal to a sum of a width of the pixel panel in the first direction and a width of the shading region between adjacent two pixel units in the first direction, and a width of the inner space defined by the outer frame in a second direction is equal to a sum of a width of the pixel panel in the second direction and a width of the shading region between adjacent two pixel units in the second direction;
during printing of adjacent two single-layer structures, a step of printing the former single-layer structure comprises:
inputting data for a printing image corresponding to the former single-layer structure to the switching elements of the pixel panel, and controlling the corresponding pixel units to be light transmissive or non-light-transmissive by the switching elements, so as to enable the pixel panel to display the printing image corresponding to the former single-layer structure,
positioning the pixel panel at a first position in the inner space defined by the outer frame, and performing a first exposure for the former single-layer structure,
moving the pixel panel to a second position in the inner space defined by the outer frame, and performing a second exposure for the former single-layer structure,
moving the pixel panel to a third position in the inner space defined by the outer frame, and performing a third exposure for the former single-layer structure, and
moving the pixel panel to a fourth position in the inner space defined by the outer frame, and performing a fourth exposure for the former single-layer structure, thereby obtaining the former single-layer structure; and
a step of printing the latter single-layer structure comprises:
inputting data for a printing image corresponding to the latter single-layer structure to the switching elements of the pixel panel, and controlling the corresponding pixel units to be light transmissive or non-light-transmissive by the switching elements, so as to enable the pixel panel to display the printing image corresponding to the latter single-layer structure,
keeping the pixel panel at the fourth position in the inner space defined by the outer frame, and performing a first exposure for the latter single-layer structure, and
sequentially moving the pixel panel to the first position, the second position and the third position in the inner space defined by the outer frame, and performing a second exposure, a third exposure and a fourth exposure for the latter single-layer structure, respectively, thereby obtaining the latter single-layer structure,
wherein the first position, the second position, the third position and the fourth position are positions obtained sequentially by moving the pixel panel clockwise or counterclockwise within the inner space defined by the outer frame, and two adjacent sides of the pixel panel overlaps with two adjacent sides of the inner space defined by the outer frame when the pixel panel is located at the first position, the second position, the third position or the fourth position.

13. The three-dimensional printing method according to claim 11, wherein the first position, the second position, the third position and the fourth position are located at a top left corner, a top right corner, a bottom right corner and a bottom left corner in the inner space defined by the outer frame, respectively.

14. The three-dimensional printing method according to claim 12, wherein the first position, the second position, the third position and the fourth position are located at atop left comer, atop right corner, a bottom right corner and a bottom left corner in the inner space defined by the outer frame, respectively.

15. The three-dimensional printing method according to claim 10, further comprising a step of:
determining an image corresponding to each single-layer structure of an object to be printed before turning on the backlight source.
